(19) United States
(12) Patent Application Publication
(10) Pub. No.: US 2024/0426000 A1
(43) Pub. Date: Dec. 26, 2024

(54) HYBRID LOW-HIGH TEMPERATURE ELECTROLYSIS WITH HEAT RECOVERY

(71) Applicant: Schlumberger Technology Corporation, Sugar Land, TX (US)

(72) Inventors: David Robert Evan Snoswell, Cambridge (GB); Joseph Wilding-Steele, Clamart (FR)

(21) Appl. No.: 18/344,906

(22) Filed: Jun. 30, 2023

(30) Foreign Application Priority Data
Jun. 20, 2023 (GB) 2309285.1

(51) Int. Cl. C25B 9/67; C25B 1/042; C25B 9/70

(52) U.S. Cl. CPC C25B 9/67; C25B 1/042; C25B 9/70

(57) ABSTRACT

The present disclosure introduces systems and related methods. Each system includes a first water electrolysis subsystem and a second water electrolysis subsystem. The first water electrolysis subsystem electrolyzes water to produce hydrogen and waste thermal energy. The second water electrolysis subsystem electrolyzes water to produce hydrogen utilizing the waste thermal energy produced by the first water electrolysis subsystem.

### BACKGROUND OF THE DISCLOSURE

Electrolysis of water is utilized for the production of hydrogen (H₂) to be used as an alternative energy source. Electrolysis of water requires just water as a feed material and converts, using an electrochemical cell, water into H₂ and dioxygen (O₂) via a redox reaction by applying a voltage to the cell. Electrolysis of water is generally implemented by an electrolyzer system that includes one or more stacks of electrochemical cells.

For example, proton exchange membrane (PEM) electrolysis is the electrolysis of water in a cell equipped with a solid polymer electrolyte which is a proton-exchange membrane. PEM electrolysis is an example of low-temperature electrolysis performed at, for example, about 80 degrees Celsius (° C.) or less. Relative to current high-temperature electrolysis systems, PEM systems are compact in size, responsive to changes in power input, less expensive, and a more mature technology. However, PEM systems are less efficient and produce excessive waste thermal energy relative to high-temperature electrolysis systems.

Examples of high-temperature electrolysis systems include a solid oxide electrolyzer cell (SOEC) in which electrolysis is performed at, for example, about 500-850° C. Relative to PEM systems, SOEC systems can have a higher efficiency, but are a less mature technology and respond less rapidly to changes in power input.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a system that includes a first water electrolysis subsystem and a second water electrolysis subsystem. The first water electrolysis subsystem electrolyzes water to produce hydrogen and waste thermal energy. The second water electrolysis subsystem electrolyzes water to produce hydrogen utilizing the waste thermal energy produced by the first water electrolysis subsystem.

The present disclosure also introduces a method that includes concurrently performing different first and second types of electrolysis. The first type of electrolysis produces a first hydrogen stream and waste thermal energy. The second type of electrolysis produces a second hydrogen stream and utilizes the waste thermal energy generated by the first type of electrolysis.

The present disclosure also introduces a system, comprising a low-temperature water electrolysis subsystem that electrolyzes water to produce hydrogen, wherein the low-temperature water electrolysis subsystem further produces waste thermal energy; and a high-temperature water electrolysis subsystem that electrolyzes water to produce hydrogen utilizing the waste thermal energy produced by the low-temperature water electrolysis subsystem.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of a hybrid electrolysis system according to one or more aspects of the present disclosure.

FIG. 2 is a schematic view of at least a portion of another example implementation of a hybrid electrolysis system according to one or more aspects of the present disclosure.

FIG. 3 is a schematic view of at least a portion of another example implementation of a hybrid electrolysis system according to one or more aspects of the present disclosure.

FIG. 4 is a block diagram of at least a portion of an example implementation of a hybrid low-high temperature electrolysis system according to one or more aspects of the present disclosure.

FIG. 5 is a flow-chart diagram of at least a portion of an example implementation of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The present disclosure introduces hybrid low-high temperature electrolyzer systems with waste thermal energy recovery. In general, such hybrid systems utilize a low-temperature electrolyzer that produces waste thermal energy and a high-temperature electrolyzer that utilizes the waste thermal energy produced by the low-temperature electrolyzer.

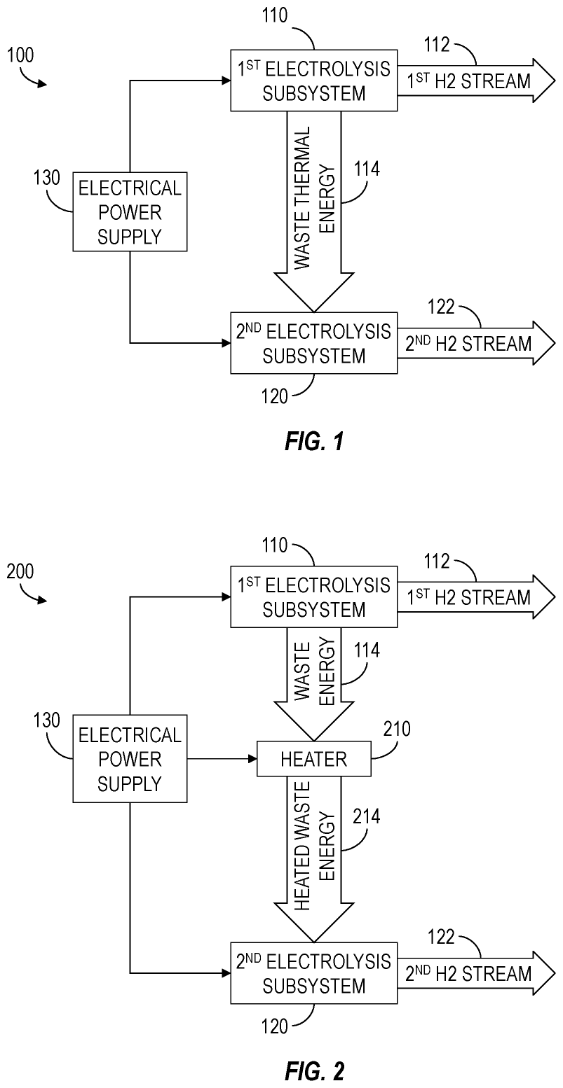

For example, FIG. 1 is a schematic view of at least a portion of an example implementation of a hybrid electrolysis system 100 according to one or more aspects of the present disclosure. The hybrid electrolysis system 100 comprises a first water electrolysis subsystem 110 and a second water electrolysis subsystem 120. The first water electrolysis subsystem 110 electrolyzes water (i.e., liquid) to produce a first H₂ stream 112 and waste thermal energy 114. The second water electrolysis subsystem 120 electrolyzes water (i.e., steam) to produce a second H₂ stream 122 utilizing the waste thermal energy 114 produced by the first water electrolysis subsystem 110.

The first and second water electrolysis subsystems 110, 120 utilize different types of electrolysis. For example, the first water electrolysis subsystem 110 may utilize a low-temperature electrolysis technology, such as PEM electrolysis of liquid water at about 80° C. or less, whereas the second water electrolysis subsystem 120 may utilize a high-temperature electrolysis technology, such as SOEC electrolysis of steam at about 500-850° C. Both types of water electrolysis subsystems are well-known in the art. Implementations within the scope of the present disclosure may use PEM, SOEC, and other existing water electrolysis subsystems without modifying the cells or stack of such subsystems. For example, although the example implementations introduced herein include PEM electrolysis as the low-temperature electrolysis, such implementations may utilize PEM electrolysis, anionic exchange membrane (AEM) electrolysis, alkaline electrolysis, other types low-temperature electrolysis, or a combination thereof. Similarly, although the example implementations introduced herein include SOEC electrolysis as the high-temperature electrolysis, such implementations may utilize SOEC electrolysis, protonic ceramic electrolysis, other types of high-temperature electrolysis, or a combination thereof.

As depicted in FIG. 1, the first and second water electrolysis subsystems 110, 120 are electrically powered by an electrical power supply 130, which may be implemented as a single, system-wide power supply or as separate power supplies (i.e., batteries, grid, etc.), each dedicated to corresponding ones of the subsystems 110, 120. For example, the first water electrolysis subsystem 110 may utilize about 55 kilowatt-hours (kWh) from the power supply 130 to produce 1 kilogram (kg) of the H₂ stream 112 along with about 11.8 kWh of the waste thermal energy 114, whereas the second water electrolysis subsystem 120 may utilize about 39 k Wh from the power supply 130 and about 9 kWh of the waste thermal energy 114 (after losses due to energy recovery and transfer) to produce 1 kg of the H₂ stream 122. Of course, this is merely an example, and other values are also within the scope of the present disclosure. The waste thermal energy 114 of the first water electrolysis subsystem is therefore recovered, such as by using a heat exchanger and/or a heat pump and by heating a heat exchange fluid (such as water) which can be re-used in the second water electrolysis system 120 by further transporting, storing, or processing the heat exchange fluid, as will be explained below.

FIG. 2 is a schematic view of at least a portion of another example implementation of a hybrid electrolysis system (designated by reference number 200) according to one or more aspects of the present disclosure. The hybrid electrolysis system 200 comprises the first and second water electrolysis subsystems 110, 120 producing the first and second H₂ streams 112, 122, as described above. The hybrid electrolysis system 200 also comprises a heater 210 that increases the temperature of a fluid (i.e., heat exchange fluid) containing at least a portion of the waste thermal energy 114 to produce steam. The steam is then utilized by the second water electrolysis subsystem 120 to electrolyze water and produce the H₂ stream 122, whether instead of the waste thermal energy 114 (as depicted in FIG. 2) or in addition to the waste thermal energy 114. The heater 210 may be or comprise a heat pump, steam generator, and/or other means for heating the heat exchange fluid. In an example implementation, the heat exchange fluid is water and the steam fed to the second water electrolysis subsystem 120 is directly produced from the heat exchange fluid, i.e., the water forming the heat exchange fluid is heated so that it becomes steam and is then fed to the second water electrolysis subsystem. In another implementation, the steam fed to the second water electrolysis subsystem 120 is indirectly produced from the heat exchange fluid, i.e., the heat exchange fluid is heated so as to transfer sufficient thermal energy to a distinct water stream to convert that water stream into steam that can be fed to the second water electrolysis system.

The heater 210 may be electrically powered by the electrical power supply 130 and/or another power supply (not shown). For example, continuing with the example described with respect to FIG. 1 in which the first water electrolysis subsystem 110 utilizes about 55 kWh of electrical energy to produce 1 kg of the H₂ stream 112 along with about 11.8 kWh of the waste thermal energy 114 (a significant portion of which is recovered and stored in the heat exchange fluid) and the second water electrolysis subsystem 120 utilizes about 39 kWh of electrical energy and about 9 kWh of the waste thermal energy 114 (taking into account the liquid-to-steam conversion) to produce 1 kg of the H₂ stream 122, the heater 210 may utilize about 3.75 kWh of electrical energy to increase the temperature of the heat exchange fluid storing waste thermal energy 114 from about 80° C. to about 150° C. to produce the increased-temperature heat exchange fluid. Of course, this is merely an example, and other values are also within the scope of the present disclosure.

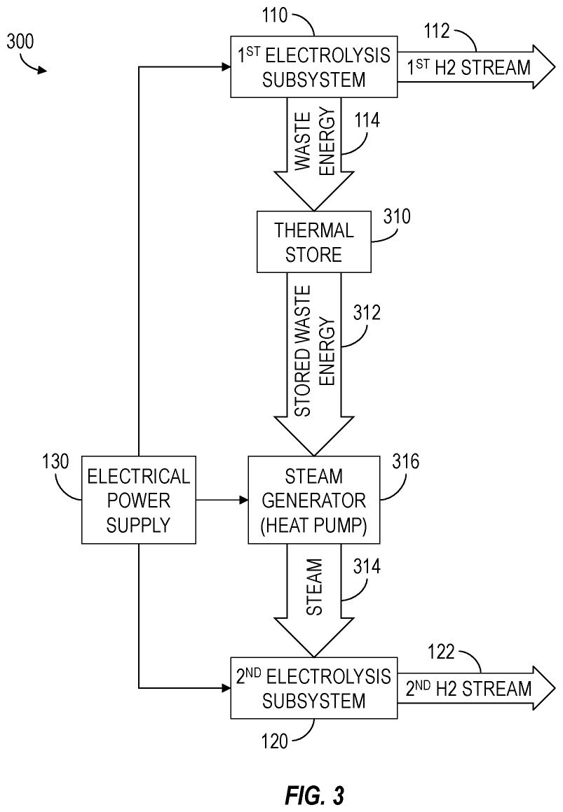

FIG. 3 is a schematic view of at least a portion of another example implementation of a hybrid electrolysis system (designated by reference number 300) according to one or more aspects of the present disclosure. The hybrid electrolysis system 300 comprises the first and second water electrolysis subsystems 110, 120 producing the first and second H₂ streams 112, 122, as described above. The hybrid electrolysis system 300 also comprises a thermal store 310 that buffers the waste thermal energy 114 produced by the first water electrolysis subsystem 110. For example, the waste thermal energy 114 may be stored in the heat exchange fluid, such as water (e.g., at about 80° C.) recovered to a water tank and/or other means that may be insulated and/or otherwise configured for reducing cooling of the recovered waste thermal energy 114. Consequently, when operating conditions of the second water electrolysis system 120 call for the thermal energy facilitated by the waste thermal energy 114, the stored waste thermal energy 312 can be available. In another implementation, the thermal store may be situated downstream of the heater and the heat exchange fluid may be stored at a temperature above 100° C., such as about 150° C. Such thermal store may include a steam accumulator.

For example, steam 314 may be generated from the stored waste thermal energy 312 by a heat pump and/or steam generator (which may run at low pressure, such as less than 20 bar) and/or other means 316 of the hybrid electrolysis system 300. A high-temperature heat pump (where the input temperature is less than 105° C. and the output temperature is greater than 110° C.) may be used that can perform both functions of heating water and providing steam. The steam 314 is then utilized by the second water electrolysis subsystem 120 to electrolyze water and produce the H₂ stream 122. All or a portion of the waste thermal energy 114, i.e., heat exchange fluid, may be converted to steam 314.

The steam generation means 316 may be electrically powered by the electrical power supply 130 and/or another power supply (not shown). For example, continuing with the example described with respect to FIG. 1 in which the first water electrolysis subsystem 110 utilizes about 55 kWh of electrical energy to produce 1 kg of the H₂ stream 112 along with about 11.8 kWh of the waste thermal energy 114 and the second water electrolysis subsystem 120 utilizes about 39 kWh of electrical energy and about 9 kWh of the waste thermal energy 114 to produce 1 kg of the H₂ stream 122, the steam generation means 316 may utilize about 3.75 kWh of electrical energy to increase the temperature of the stored heat exchange fluid from about 80° C. to about 150° C. to produce the steam 314. Of course, this is merely an example, and other values are also within the scope of the present disclosure.

The example hybrid electrolysis systems 100, 200, 300 described above, as well as other hybrid electrolysis systems also within the scope of the present disclosure, may include additional components not depicted in FIGS. 1-3 or otherwise explicitly described herein. Examples of such additional components may include coolers, driers, fans, filters, heat exchangers, pumps, purifiers, separators, vessels, and/or other processing components. One or more aspects depicted in just one or two of FIGS. 1-3 may also be utilized in the other implementations of FIGS. 1-3 and/or other implementations also within the scope of the present disclosure.

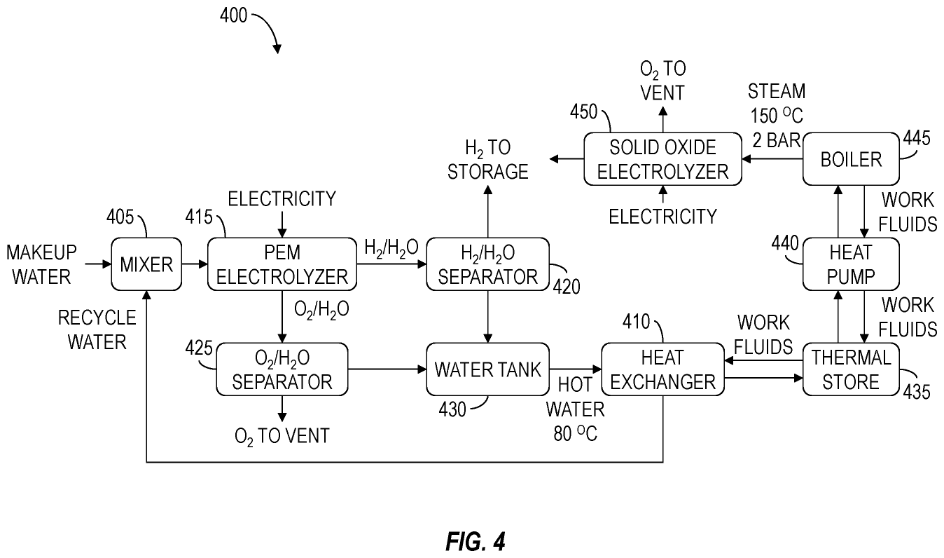

FIG. 4 is a block diagram of at least a portion of an example implementation of a hybrid electrolysis system 400 according to one or more aspects of one or more of the hybrid electrolysis systems 100, 200, 300 described above and depicted in FIGS. 1-3, respectively. The hybrid electrolysis system 400 includes a mixer 405 that mixes water received from a heat exchanger 410 and sufficient makeup water to feed a PEM or other low temperature electrolyzer 415 (e.g., the first electrolysis subsystem 110 shown in FIGS. 1-3). The PEM electrolyzer 415 outputs: (1) a hydrogen/water (H₂/H₂O) stream to an H₂/H₂O separator 420; and (2) a dioxygen/water (O₂/H₂O) stream to an O₂/H₂O separator 425. The H₂ separated by the H₂/H₂O separator 420 (e.g., the first H₂ stream 112 shown in FIGS. 1-3) is sent to storage, the O₂ separated by the O₂/H₂O separator 425 is vented, and the H₂O separated by the separators 420, 425 is directed to a water tank and/or other water storage means 430. The H₂O is constituted by hot water at a temperature about 80° C.

The hot water (e.g., at about 80° C.) is fed to the heat exchanger 410. Work fluids (i.e., heat exchange fluid) traveling between the heat exchanger 410 and a thermal store 435 (e.g., the thermal store 310 shown in FIG. 3) transfer waste thermal energy from the hot water to the thermal store 435, and the resulting cooler water output from the heat exchanger is directed back to the mixer 405. The resulting hotter water output from the heat exchanger is directed to the thermal store 435. The thermal store 435 may be or comprise a low pressure (e.g., less than 20 bar) steam accumulator.

Additional work fluids travel between the thermal store 435 and a heat pump 440 to heat additional work fluids traveling between the heat pump 440 and a boiler 445. The heat pump 440 and the boiler 445 may collectively form the steam generator (heat pump) 316 shown in FIG. 3. The input temperature of the heat pump 440 may be less than 105° C., whereas the output temperature of the heat pump 440 is greater than 110° C. Steam generated by the boiler 445 is fed to an electrically powered SOEC or other high temperature electrolyzer 450 (e.g., the second electrolysis subsystem 120 shown in FIGS. 1-3). The steam generated by the boiler 445 may be at about 150° C. and about 2 bar, which differentiates the boiler 445 from boilers used for power generation that generate steam at a pressure greater than 20 bar. O₂ generated by the SOEC 450 is vented, whereas H₂ generated by the SOEC 450 (e.g., the second H₂ stream 122 shown in FIGS. 1-3) is sent to storage along with the H₂ separated by the H₂/H₂O separator 420.

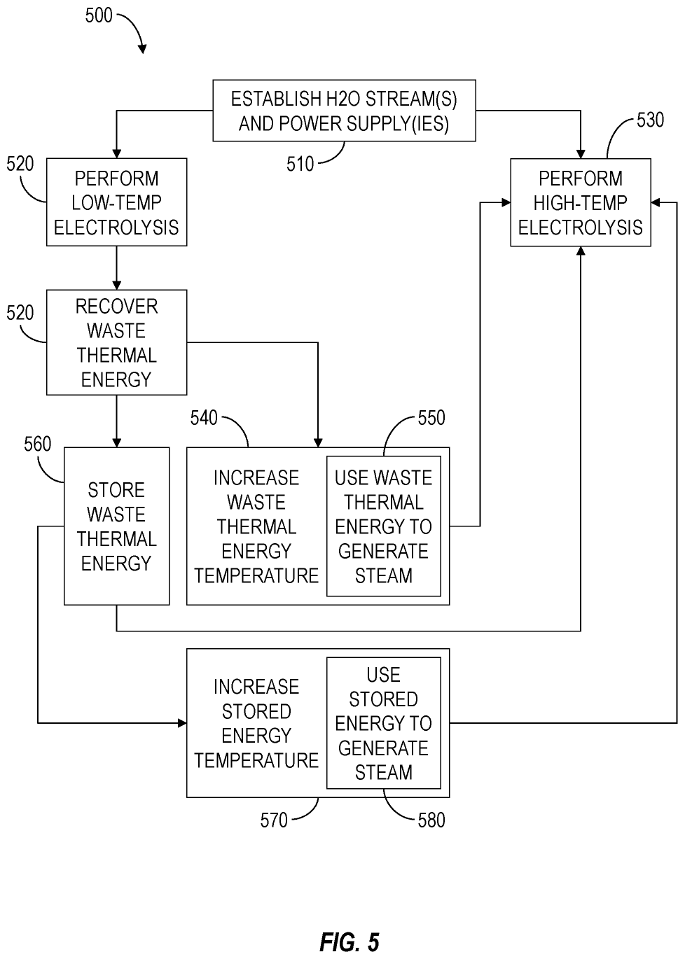

FIG. 5 is a flow-chart diagram of at least a portion of an example implementation of a method 500 according to one or more aspects of the present disclosure. The method 500 may be performed utilizing one or more aspects of the example hybrid electrolysis systems described herein, including the example hybrid electrolysis systems 100, 200, 300, 400 depicted in FIGS. 1-4, respectively.

The method 500 may include establishing 510 one or more water (liquid and/or steam) streams and/or one or more electrical power supplies by which H₂ will be produced according to aspects introduced herein. The method 500 comprises concurrently performing 520, 530 different first and second types of electrolysis. For example, the method 500 may comprise concurrently performing 520 PEM and/or another low-temperature electrolysis and performing 530 SOEC and/or another high-temperature electrolysis, as described above. Performing 520 the first type (e.g., low temperature) of electrolysis produces a first hydrogen stream and waste thermal energy, and performing 530 the second type (e.g., high temperature) of electrolysis produces a second hydrogen stream and utilizes the waste thermal energy generated by performing 520 the first type of electrolysis.

The method 500 may comprise recovering 525 waste thermal energy, such as into a heat exchange fluid, and increasing 540 the temperature of the heat exchange fluid, such that performing 530 the second type of electrolysis utilizes the increased-temperature heat exchange fluid (directly or indirectly as explained above). Such an implementation may utilize the hybrid water electrolysis system 200 depicted in FIG. 2. For example, increasing 540 the temperature of the heat exchange fluid may comprise using 550 the heat exchange fluid (produced by performing 520 the first type of electrolysis) to generate steam to be utilized to perform 430 the second type of electrolysis.

The method 500 may comprise buffering the waste thermal energy by storing 560 the waste thermal energy in a thermal store (e.g., storing the heat exchange fluid in the thermal store). Performing 530 the second type of electrolysis may include receiving the waste thermal energy from the thermal store. The method 500 may comprise increasing 570 the temperature of the heat exchange fluid, such that performing 530 the second type of electrolysis utilizes the increased-temperature heat exchange fluid. Such an implementation may utilize the hybrid water electrolysis system 300 depicted in FIG. 3. For example, increasing 570 the temperature of the heat exchange fluid may comprise using 580 the stored heat exchange fluid to generate steam to be utilized to perform 530 the second type of electrolysis.

A hybrid low-high temperature electrolyzer system with waste thermal energy recovery according to one or more aspects described above, whether with respect to one or more of FIGS. 1-4 and/or otherwise, may unite the advantages of different electrolysis technologies. For example, the system efficiency can be increased compared to a standalone low temperature electrolyzer system, while still utilizing the lower cost and more mature PEM electrolyzers for a majority of the overall system. Cooling fans for removing waste thermal energy from a PEM system could be reduced or eliminated, resulting in reduced capital expenditures. The hybrid system may provide enhanced flexibility (e.g., ramp rate and/or responsiveness) compared to a standalone high temperature electrolyzer system. An additional potential advantage may be the possibility to add an optional thermal store to the system, which may permit a form of energy storage to be easily integrated, further increasing system flexibility. A hybrid electrolysis system may also facilitate an increased number of applications for SOEC and/or other high temperature electrolysis, perhaps including implementations with waste heat availability constraints being reduced.

In view of the entirety of the present disclosure, including the figures and the claims, a person having ordinary skill in the art will readily recognize that the present disclosure introduces a system, comprising: a first water electrolysis subsystem that electrolyzes water to produce hydrogen, wherein the first water electrolysis subsystem further produces waste thermal energy; and a second water electrolysis subsystem that electrolyzes water to produce hydrogen utilizing the waste thermal energy produced by the first water electrolysis subsystem.

A first one of the first and second water electrolysis subsystems may utilize a low-temperature electrolysis technology, and a second one of the first and second water electrolysis subsystems may utilize a high-temperature electrolysis technology.

The low-temperature electrolysis technology may be PEM electrolysis, AEM electrolysis, alkaline electrolysis, or a combination thereof.

The high-temperature electrolysis technology may be SOEC electrolysis or protonic ceramic electrolysis.

The waste thermal energy of the first water subsystem may be recovered into a heat exchange fluid. The system may comprise a heater that increases the temperature of the heat exchange fluid, wherein the second water electrolysis subsystem may utilize the increased-temperature heat exchange fluid to electrolyze water. The system may comprise a thermal store that buffers the waste thermal energy produced by the first water electrolysis subsystem. The thermal store may be situated upstream and/or downstream of the heater. The thermal store may be situated downstream of the heater and may be a steam accumulator.

The system may comprise a steam generator that utilizes the waste thermal energy to generate steam, wherein the second water electrolysis subsystem may utilize the generated steam to electrolyze water.

The present disclosure also introduces a method comprising concurrently performing different first and second types of electrolysis, wherein: the first type of electrolysis produces a first hydrogen stream and waste thermal energy; and the second type of electrolysis produces a second hydrogen stream and utilizes the waste thermal energy generated by the first type of electrolysis.

A first one of the first and second types of electrolysis may be low-temperature electrolysis, such as PEM electrolysis, AEM electrolysis, alkaline electrolysis, or a combination thereof, and a second one of the first and second types of electrolysis may be a high-temperature electrolysis, such as SOEC electrolysis or protonic ceramic electrolysis.

The method may include recovering the waste thermal energy of the first type of electrolysis into a heat exchange fluid. In such implementations, among others within the scope of the present disclosure, the method may comprise increasing the temperature of heat exchange fluid, wherein the second type of electrolysis may utilize the increased-temperature heat-exchange fluid.

The method may comprise utilizing the waste thermal energy to generate steam, wherein the second type of electrolysis may utilize the generated steam.

The method may comprise buffering the waste thermal energy utilizing a thermal store. In such implementations, among others within the scope of the present disclosure, the second type of electrolysis may receive the waste thermal energy from the thermal store.

The disclosure also relates to a system, comprising a low-temperature water electrolysis subsystem that electrolyzes water to produce hydrogen, wherein the low-temperature water electrolysis subsystem further produces waste thermal energy; and a high-temperature water electrolysis subsystem that electrolyzes water to produce hydrogen utilizing the waste thermal energy produced by the low-temperature water electrolysis subsystem.

In an embodiment, the low-temperature (LT) electrolysis subsystem is proton exchange membrane (PEM) electrolysis subsystem, anionic exchange membrane (AEM) electrolysis subsystem, alkaline electrolysis subsystem, or a combination thereof.

In an embodiment the high-temperature (HT) electrolysis subsystem is solid oxide electrolysis cell (SOEC) electrolysis subsystem.

The waste thermal energy of the low-temperature electrolysis subsystem may be recovered into a heat exchange fluid. The system may comprise a heater that increases the temperature of the heat exchange fluid, wherein the high-temperature electrolysis subsystem may utilize the increased-temperature heat exchange fluid to electrolyze water. The system may comprise a thermal store that buffers the waste thermal energy produced by the LT electrolysis subsystem. The thermal store may be situated upstream and/or downstream of the heater. The thermal store may be situated downstream of the heater and may be a steam accumulator.

The system may comprise a steam generator that utilizes the waste thermal energy to generate steam, wherein HT electrolysis subsystem may utilize the generated steam to electrolyze water.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the scope of the present disclosure.

The Abstract at the end of this disclosure is provided to permit the reader to quickly ascertain the nature of the technical disclosure. It is submitted with the understanding that it will not be used to interpret or limit the scope or meaning of the claims.

What is claimed is:

1. A system, comprising:
a first water electrolysis subsystem that electrolyzes water to produce hydrogen, wherein the first water electrolysis subsystem further produces waste thermal energy; and
a second water electrolysis subsystem that electrolyzes water to produce hydrogen utilizing the waste thermal energy produced by the first water electrolysis subsystem.

2. The system of claim 1 wherein:
a first one of the first and second water electrolysis subsystems utilizes a low-temperature electrolysis technology; and
a second one of the first and second water electrolysis subsystems utilizes a high-temperature electrolysis technology.

3. The system of claim 2 wherein the low-temperature electrolysis technology is proton exchange membrane (PEM) electrolysis, anionic exchange membrane (AEM) electrolysis, alkaline electrolysis, or a combination thereof.

4. The system of claim 2 wherein the high-temperature electrolysis technology is solid oxide electrolysis cell (SOEC) electrolysis.

5. The system of claim 1 wherein the waste thermal energy of the first water subsystem is recovered into a heat exchange fluid.

6. The system of claim 5 further comprising a heater that increases the temperature of the heat exchange fluid, wherein the second water electrolysis subsystem utilizes the increased-temperature heat exchange fluid to electrolyze water.

7. The system of claim 1 further comprising a steam generator that utilizes the waste thermal energy to generate steam, wherein the second water electrolysis subsystem utilizes the generated steam to electrolyze water.

8. The system of claim 1 further comprising a thermal store that buffers the waste thermal energy produced by the first water electrolysis subsystem.

9. The system of claim 8, wherein the waste thermal energy of the first water subsystem is recovered into a heat exchange fluid, wherein the system further comprises a heater that increases the temperature of the heat exchange fluid, wherein the second water electrolysis subsystem utilizes the increased-temperature heat exchange fluid to electrolyze water, and wherein the thermal store is situated upstream and/or downstream of the heater.

10. The system of claim 9 wherein the thermal store is situated downstream of the heater and is a steam accumulator.

11. A method, comprising:
concurrently performing different first and second types of electrolysis, wherein:
the first type of electrolysis produces a first hydrogen stream and waste thermal energy; and
the second type of electrolysis produces a second hydrogen stream and utilizes the waste thermal energy generated by the first type of electrolysis.

12. The method of claim 11 wherein:
a first one of the first and second types of electrolysis is low-temperature electrolysis, such as proton exchange membrane (PEM) electrolysis, anionic exchange membrane (AEM) electrolysis, alkaline electrolysis, or a combination thereof; and
a second one of the first and second types of electrolysis is a high-temperature electrolysis, such as solid oxide electrolysis cell (SOEC) electrolysis or protonic ceramic electrolysis.

13. The method of claim 11 including recovering the waste thermal energy of the first type of electrolysis into a heat exchange fluid.

14. The method of claim 13 further comprising increasing the temperature of heat exchange fluid, wherein the second type of electrolysis utilizes the increased-temperature heat-exchange fluid.

15. The method of claim 11 further comprising utilizing the waste thermal energy to generate steam, wherein the second type of electrolysis utilizes the generated steam.

16. The method of claim 11 further comprising buffering the waste thermal energy utilizing a thermal store.

17. The method of claim 16 wherein the second type of electrolysis receives the waste thermal energy from the thermal store.

18. A system, comprising:
a low-temperature water electrolysis subsystem that electrolyzes water to produce hydrogen, wherein the low-temperature water electrolysis subsystem further produces waste thermal energy; and
a high-temperature water electrolysis subsystem that electrolyzes water to produce hydrogen utilizing the waste thermal energy produced by the low-temperature water electrolysis subsystem.

19. The system of claim 18, wherein the low-temperature electrolysis subsystem is proton exchange membrane (PEM) electrolysis subsystem, anionic exchange membrane (AEM) electrolysis subsystem, alkaline electrolysis subsystem, or a combination thereof.

20. The system of claim 18, wherein the high-temperature electrolysis subsystem is solid oxide electrolysis cell (SOEC) electrolysis subsystem.
